(19) United States
(12) Patent Application Publication
(10) Pub. No.: US 2004/0144027 A1
(43) Pub. Date: Jul. 29, 2004

(54) Plant starter pot with removable base

(76) Inventor: Charles B. Dines, Fairfax, CA (US)

Correspondence Address: JOHNSON & STAINBROOK, LLP, Suite 203, 3550 Round Barn Blvd., Santa Rosa, CA, 95403, US

(21) Appl. No.: 10/758,881

(22) Filed: Jan. 16, 2004

Related U.S. Application Data
(60) Provisional application No. 60/440,802, filed on Jan. 16, 2003.

(51) Int. Cl. A01G 9/02

(52) U.S. Cl. 47/66.1

(57) ABSTRACT

A plant starter pot having a main body, a base member, and connection means that allows for selective connection of the base member to the main body and selective removal from the main body. A base-removing tool is provided to facilitate removal of the base member from the main body when a plant is suitably mature.

### CROSS REFERENCE TO RELATED APPLICATIONS

The present application claims the benefit of the filing date of U.S. Provisional Patent Application, Ser. No. 60/440,802, filed Jan. 16, 2003.

### STATEMENT REGARDING FEDERALLY SPONSORED RESEARCH OR DEVELOPMENT

Not applicable.

### REFERENCE TO A MICROFICHE APPENDIX

Not applicable.

### TECHNICAL FIELD

The present invention relates generally to plant starter pots, and more particularly to plant starter pot having a selectively removable base for facilitating an intact transplantation of the developing plant.

### BACKGROUND INFORMATION AND DISCUSSION OF RELATED ART

Starter pots are employed for a number of purposes, most notably to ensure tight control over the initial conditions under which a plant germinates and begins the early stages of its growth. In a properly selected pot, a plant's water, soil, light, and nutrient needs can be monitored and carefully regulated. The wide variety of starter pots in use defy a brief survey. In consequence, the discussion of related art that follows is intended to provide a concise consideration of just a small sample of starter pot types. The following designs show how plant starter pots can be adapted for several different purposes.

U.S. Pat. No. 4,040,207, to Lancaster, for instance, discloses a double-walled pot having an inner pot nested within an outer pot. In this design, the nested and nesting pots are fabricated from impermeable material and configured with a separating space. The nested pot includes holes in its bottom. Time-released fertilizer is affixed to the outside wall of the inner pot, such that when water is poured into the annular gap between the upper rims of the respective pots, it percolates downwardly to the bottom of the nested pot and migrates to the soil containing plant roots. This patent, then, is illustrative of a method of providing nutrients to a plant through nested pots. U.S. Pat. No. 4,791,755, to Bilstein, also teaches a permeable pot nested within an impermeable one, with much the same end in view.

U.S. Pat. No. 4,027,429, to Georgi, teaches a plastic starter pot having an aperture in the bottom wall. The aperture is spaced from the side walls of the pots and has an upturned lip around its periphery to form an annular water reservoir. A detachable disc is enclosed within the pot and rests on the upturned lip to support soil in the pot and to prevent the soil from entering the water reservoir space. The disc has apertures to permit water drainage. An annular on the bottom of the disc overlaps the upturned lip to prevent water from escaping the reservoir space.

U.S. Pat. No. 4,043,077, to Stonehocker, shows an expandable starter pot having sides with corrugated, accordion-like folds that expand to accommodate plant root growth. Soil is added over the course of the expansion to maintain an appropriate surface level of the soil.

U.S. Pat. No. 4,161,844, to Hentschel et al., teaches a hydroculture plant pot with an annular central compartment containing an inserted container for receiving a hydroculture fertilizer. The inserted container has apertures sized smaller than the particles of the hydroculture fertilizer.

U.S. Pat. No. 5,852,896, to Flasch, Jr., discloses a plant pot having an inner annular wall with transverse holes around its circumference and up its length. The inner wall includes a water impervious circumferential band at its upper end to maintain the soil top surface dry by preventing the lateral in-flow of irrigation water. The pot further includes an outer annular wall spaced apart from the inner wall to define an open space with upper opening between the walls into which irrigation water can be applied and air may flow. The space between the walls at the bottom end of the space is sealed with a floor. The bottom floor includes drain holes.

U.S. Pat. No. 5,044,120, to Couch, shows a double-walled plant pot, as in Flasch, Jr., but having a permeable inner side wall, and an impermeable outer side wall. The space between the walls may be filled with fertilizer with varying concentrations according to depth. Larger plants obtain more fertilizing nutrients. The inner wall, bottom, and outside may be separable.

U.S. Pat. No. 6,038,813, to Moore, et al., teaches a plant pot having a side wall and first and second axially spaced-apart bottom portions. The inner wall and second portion have a dimension to support a second container within the side wall and the inner wall of the container includes at least one drain opening so that the container retains water at a level at or below the second bottom portion.

U.S. Pat. No. 6,536,159, to Van Den Ende, discloses a plant pot having a first and second spaces bounded by respective upright walls and a bottom. The first and second spaces are separated by a porous plate. The plant pot also includes a third space bounded by a third upright wall and a bottom that surrounds the second space, and the second space serves to accommodate a moisture-retaining, hydrating but air-permeable material.

The foregoing patents reflect the current state of the art of which the present inventor is aware. Reference to, and discussion of, these patents is intended to aid in discharging Applicant's acknowledged duty of candor in disclosing information that may be relevant to the examination of claims to the present invention. However, it is respectfully submitted that none of the above-indicated patents disclose, teach, suggest, show, or otherwise render obvious, either singly or when considered in combination, the invention described and claimed herein.

### BRIEF SUMMARY OF THE INVENTION

The present invention is plant starter pot having a selectively removable base to facilitate intact transplantation of a growing plant. It is therefore an object of the present invention to provide a new and improved plant starter pot having a selectively removable base, which allows for increased drainage, if desired, and which facilitates intact transplantation when a plant's root structure is sufficiently mature. Other novel features which are characteristic of the invention, as to organization and method of operation, together with further objects and advantages thereof will be better understood from the following description considered in connection with the accompanying drawings, in which preferred embodiments of the invention are illustrated by way of example. It is to be expressly understood, however, that the drawings are for illustration and description only and are not intended as a definition of the limits of the invention. The various features of novelty which characterize the invention are pointed out with particularity in the claims annexed to and forming part of this disclosure. The invention resides not in any one of these features taken alone, but rather in the particular combination of all of its structures for the functions specified.

There has thus been broadly outlined the more important features of the invention in order that the detailed description thereof that follows may be better understood, and in order that the present contribution to the art may be better appreciated. There are, of course, additional features of the invention that will be described hereinafter and which will form additional subject matter of the claims appended hereto. Those skilled in the art will appreciate that the conception upon which this disclosure is based readily may be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the Abstract is to enable the U.S. Patent and Trade-mark Office and the public generally, and especially the scientists, engineers and practitioners in the art who are not familiar with patent or legal terms or phraseology, to determine quickly from a cursory inspection the nature and essence of the technical disclosure of the application. The Abstract is neither intended to define the invention of this application, which is measured by the claims, nor is it intended to be limiting as to the scope of the invention in any way.

Certain terminology and derivations thereof may be used in the following description for convenience in reference only, and will not be limiting. For example, words such as “upward,” “downward,” “left,” and “right” would refer to directions in the drawings to which reference is made unless otherwise stated. Similarly, words such as “inward” and “outward” would refer to directions toward and away from, respectively, the geometric center of a device or area and designated parts thereof. References in the singular tense include the plural, and vice versa, unless otherwise noted.

### BRIEF DESCRIPTION OF THE SEVERAL VIEWS OF THE DRAWINGS

The invention will be better understood and objects other than those set forth above will become apparent when consideration is given to the following detailed description thereof. Such description makes reference to the annexed drawing wherein:

FIG. 1 is a cross-sectional side view in elevation of a first preferred embodiment of the plant pot with a removable bottom of the present invention;

FIG. 2 is a top view of the base of the first preferred embodiment of the present invention;

FIG. 3 is an exploded perspective view showing use of a specialized tool employed to removed the base after a plant has taken root in soil contained within the pot;

FIG. 4 is a perspective view showing a technique for using the specialized tool to remove the base;

FIG. 5 is a perspective view of a third preferred embodiment of the starter pot of the present invention.

### DRAWING REFERENCE NUMERALS

100 plant starter pot, generally

110 main body

120 upper end of main body

130 first opening of main body

140 lower end of main body

150 second opening of main body

160 base member

170 drain hole

180 exterior threads on main body

180′ interior threads in base member

190 rim

200 second preferred embodiment

210 threaded pot base

220 first hole

230 second hole

240 geometric center of the base

250 base removing tool

260 planar bar

270 first stud

280 second stud

290 user's foot

300 user's foot

310 first end portion

320 second end portion

330 pot body

340 upper rim of pot body

400 third preferred embodiment

410 starter pot body

420 first side

430 second side

440 third side

450 fourth side

460 base-engaging portion

470 open top

480 open bottom

490 tray

500 side portion

510 side portion

520 tongue

530 tongue

540 groove

550 groove

560 exterior surface of side 500

570 exterior surface of side 510

580 drain holes

P plant

R roots

S nutrient medium

U user

### DESCRIPTION OF THE PREFERRED EMBODIMENTS OF THE INVENTION

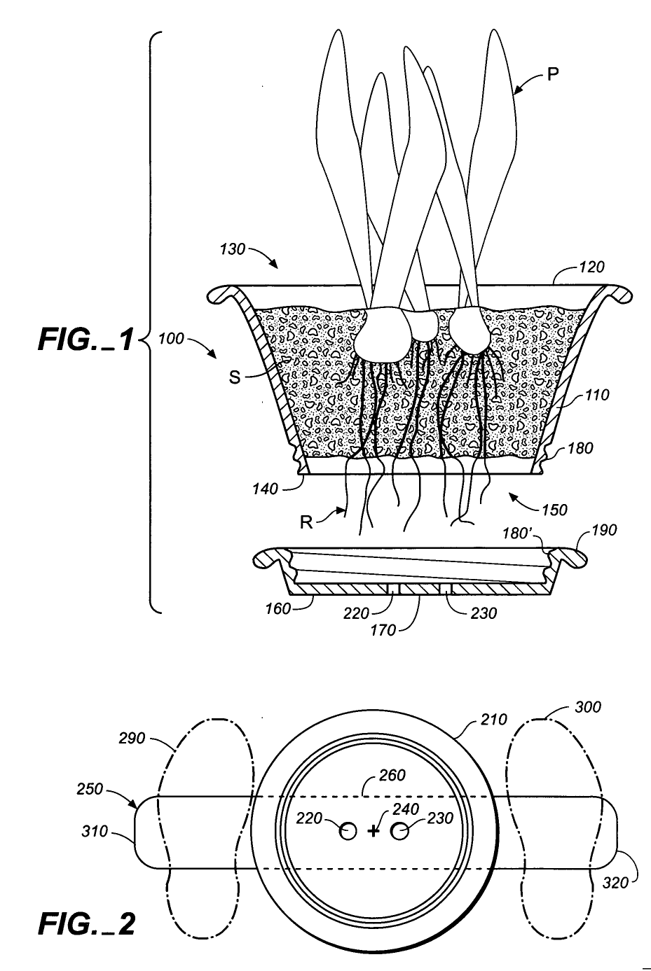

Referring to FIG. 1, a cross-sectional side view in elevation of the inventive apparatus, this view shows that the plant pot with a removable base of the present invention, generally denominated 100 herein, comprises a main body 110, preferably a truncated cone in shape (defining a frustum), and having an upper end 120 with a first opening 130 and a lower end 140 with a second opening 150. The pot further comprises a generally circular base member 160 having a bottom drain hole 170. The main body includes threads 180 on its exterior surface proximate the lower end and which selectively mate with interior threads 180′ in a rim 190 of the base member, the latter structure forming a kind of socket into which the main body is threadably inserted. Accordingly, the base member may be installed on the main body by aligning the matable threads and turning the base member relative to the main body. Conversely, when desired, the base may be selectively removed from the main body by turning main body, or the base, in the opposite direction relative to the other member.

As will be readily appreciated by those with skill in the art, any of a number of suitable alternative means for connecting the base member to the main body may be employed, including a bayonet fitting, a friction fit, snaps or clips, and the like. Additionally, when the pot is made of sufficiently pliable material easily punctured by a tool such as a screwdriver, the base can be integrated into the main body, which is provided with perforations comprising a plurality of side-by-side holes defining a ring which circumscribes the main body near its lower end. Thus, the base of the main body can be removed simply by punching in the holes and pulling off the base. The essential feature is that the base member, comprising a cover for the bottom opening in the main body, be removable in its entirety and that the bottom opening be exposed in substantially its entirety through the removal of the base member.

According to the present invention, when a plant P develops to the point that its roots require more space, either because the plant is becoming root bound or because the pot can no longer contain sufficient water or nutrients to provide optimally for the plant's metabolic needs, then the base member can be removed. This allows the roots R to emerge from the bottom of the pot and the nutrient medium S and facilitates placement of the pot in a larger pot or, alternatively, stacking in an identically sized starter pot. In either case, this procedure keeps the root structure substantially intact, minimized transplant shock, and exposes the roots to additional soil, space, water and other nutrients, thereby obviating the need for conventional transplanting.

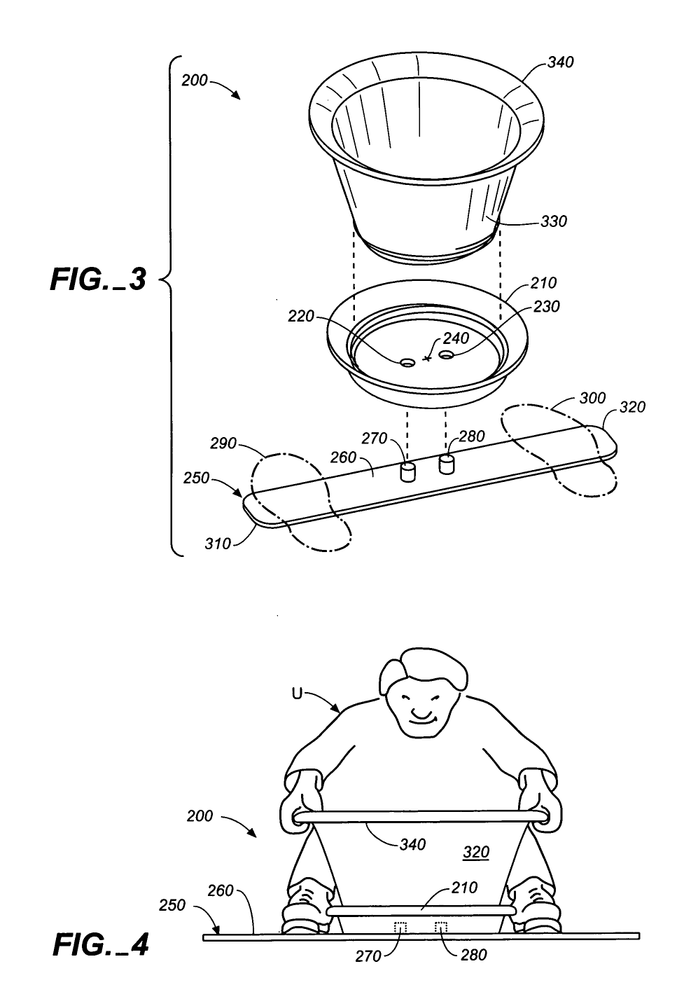

A preferred method of removing the base, particularly in larger pots, is shown in FIGS. 2 through 4. In a second preferred embodiment of the present invention, generally denominated 200, the threaded pot base 210 includes first and second holes 220, 230, located on opposite sides of the geometric center 240 of the pot. A specialized base removing tool 250 is provided, said tool comprising a length of generally planar bar 260 and having first and second studs 270, 280 shaped and sized for a snug but easy insertion into first and second holes 220, 230. If the holes in the base member are substantially circular, then the studs are preferably substantially cylindrical. When a plant is readily for transplanting from the pot to a larger pot or to the ground, the pot is placed over the tool and the studs inserted into the base member holes. The user U then stands, placing his or her feet 290, 300 on first and second end portions 310, 320 of the bar 260. The pot body 330 is then grasped at its upper rim 340 and twisted off the base (see FIG. 4). This method of removing the base is particularly useful when working with plants that have grown over a long period of time in a large starter pot. The accumulation of dirt and other contaminants in the plant base can work into the threads or other connection means and make removal difficult without the mechanical advantage provided by the base removing tool.

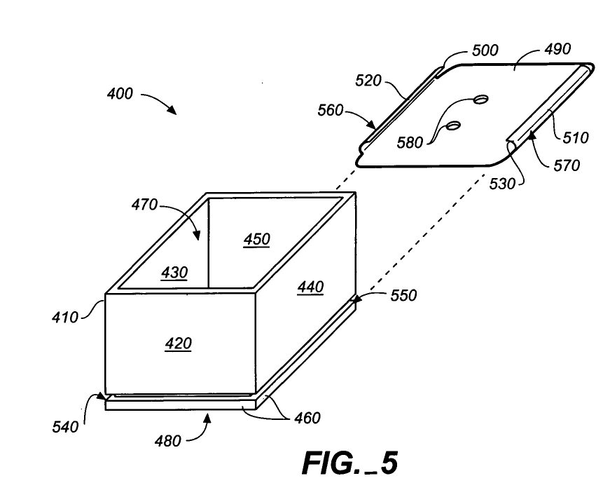

As will be appreciated, the inventive starter pot could be fashioned in any of a number of suitable shapes. Rather than having a frusto-conical shape, the pot body could be substantially cylindrical, or it could be polygonal. For instance, in a third preferred embodiment 400, shown in FIG. 5, the starter pot body 410 is generally cuboid and includes first through fourth sides 420, 430, 440, 450, a base-engaging portion 460, an open top 470 and an open bottom 480. A substantially planar tray or base 490 is provided to cover the opening at the bottom of the pot, the tray having two opposing vertically-disposed side portions 500, 510, each having a tongue 520, 530, which slides into a corresponding groove 540, 550 on opposing sides of the pot body in the base-engaging portion. The exterior surfaces 560, 570 of sides 500, 510 may be provided with surface features to assist in removing the tray once the plant had been established. Alternatively, handles of one kind or another could be integrated into the sides. Accordingly, the principle of operation of this embodiment would obtain for any suitable polygonal shape given to the pot body. Additionally, tray 490 may be provided with drain holes 580, though drainage may also be facilitated by spacing the tray surface from the base-engaging portion of the pot body through the dimensioning of the side portions and tongues of the tray.

The above disclosure is sufficient to enable one of ordinary skill in the art to practice the invention, and provides the best mode of practicing the invention presently contemplated by the inventor. While there is provided herein a full and complete disclosure of the preferred embodiments of this invention, it is not desired to limit the invention to the exact construction, dimensional relationships, and operation shown and described. Various modifications, alternative constructions, changes and equivalents will readily occur to those skilled in the art and may be employed, as suitable, without departing from the true spirit and scope of the invention. Such changes might involve alternative materials, components, structural arrangements, sizes, shapes, forms, functions, operational features or the like.

Accordingly, the above description and illustrations should not be construed as limiting the scope of the invention, which is defined by the appended claims.

What is claimed as invention is:

1. A plant starter pot, comprising:
a main body having an upper end with a first opening and a lower end with a second opening, and an exterior surface;
a selectively removable base member having at least one bottom drain hole;
base connection means for connecting said removable base member to said main body.

2. The plant starter pot of claim 1, wherein said main body is frusto-conical in shape and defines a frustum, and wherein said base member is generally circular and has a geometric center.

3. The plant starter pot of claim 2, wherein said base member includes a rim having threads disposed on the interior of said rim, and wherein said base connection means comprises threads disposed on said exterior surface of said main body proximate said lower end and adapted for matable insertion into said rim of said base member.

4. The plant starter pot of claim 3, wherein said base member has at least two drain holes, at least two of which are spaced substantially equidistant from said geometric center of said base member.

5. The plant starter pot of claim 4, further including a base-removing tool, said base-removing tool comprising a generally planar bar and having first and second studs adapted for insertion in the holes of said base member.

6. The plant starter pot of claim 1, wherein said base connection means is selected from the group consisting of bayonet fitting, snap fitting, snaps, and clips.

7. The plant starter pot of claim 1, wherein said base member is integral with said main body and said main body includes a plurality of side-by-side perforations defining a ring proximate said lower end of said main body, and which when punctured permit said base to be removed from said main body.

8. The plant starter pot of claim 1, wherein main body is polygonal.

9. The plant starter pot of claim 8, wherein said main body has at least four sides, said main body having a base-engaging portion proximate said lower end, said base-engaging portion including at least two grooves on opposing sides; and wherein said base member comprises a substantially planar tray having at least two vertically disposed sides with tongues adapted for slidable insertion into the grooves of said base-engaging portion.

10. A method of performing an intact transplantation of a plant from a starter pot to another container and/or ground, said method comprising the steps of:
providing a plant starter pot having a frusto-conical main body having an upper end with a first opening and a lower end with a second opening, an exterior surface, and threads disposed on said exterior surface proximate said lower end; a selectively removable, substantially circular base member having a geometric center and at least two drain holes equidistant from the geometric center, and further including a rim having interior threads adaptable for matable connection with the threads on the exterior surface of the main body;
connecting the base member to the main body;
filling the main body with soil and/or other nutrient media;
growing the plant to a suitable point in its development;
providing a base-removing tool which comprises a generally planar bar having first and second spaced-apart studs adapted for insertion in the holes of the base member;
placing the pot over the base-removing tool so as to insert the studs into the base member holes;
turning the main body of the starter pot relative to the base member so as to disengage the main body from the base member.
